(19) United States
(12) Patent Application Publication
(10) Pub. No.: US 2025/0154437 A1
(43) Pub. Date: May 15, 2025

(54) CONCENTRATED FREE-FLOWING DETERGENT COMPOSITION HAVING IMPROVED PROPERTIES

(71) Applicant: HENKEL AG & CO. KGAA, Düsseldorf (DE)

(72) Inventors: Inga Kerstin VOCKENROTH, Düsseldorf (DE); Eva-Maria WIKKER, Monheim (DE)

(21) Appl. No.: 18/836,371

(22) PCT Filed: Jan. 4, 2023
(86) PCT No.: PCT/EP2023/050120

§ 371 Date: Aug. 7, 2024

(30) Foreign Application Priority Data
Feb. 14, 2022 (DE) 10 2022 201 498.7

(51) Int. Cl. C11D 1/86; C11D 1/22; C11D 1/44; C11D 1/72; C11D 3/33; C11D 17/04

(52) U.S. Cl. CPC C11D 1/86; C11D 3/33; C11D 17/043; C11D 1/22; C11D 1/44; C11D 1/72

(57) ABSTRACT

A flowable detergent preparation includes a) 0.5 to 10 wt. % of a polyalkoxylated amine having a weight-average molecular weight Mw in the range from 600 g/mol to 10,000 g/mol, b) 0.1 to 5 wt. % of at least one builder selected from the group consisting of aminocarboxylic acids and salts thereof, c) 12 to 40 wt. % of anionic surfactant, d) 12 to 40 wt. % of non-ionic surfactant, and e) less than 20 wt. % of water.

The present invention relates to a highly concentrated detergent preparation. Furthermore, the application relates to detergent portion units which comprise this detergent preparation, and to a method for washing textiles using the detergent preparation or the detergent portion unit.

Continuously changing requirements are placed on the forms of manufacture and supply of washing and cleaning agents. The main focus has, for quite some time, been on the convenient dosing of detergents and cleaning agents by the consumer and the simplification of the work steps necessary for carrying out a washing or cleaning method. A technical solution is provided by pre-portioned detergents or cleaning agents, for example film pouches comprising one or more receiving chambers for solid or liquid detergents or cleaning agents.

A trend relevant to the production of these film pouches is the miniaturization of these film pouches. In addition to higher consumer acceptance due to simplified handling, the background of this development is, in particular, sustainability aspects, for example in relation to transport volumes and costs and the quantity of packaging materials used.

The concentration of modern detergents, in particular modern liquid detergents, generally influences their optical and rheological properties, has effects on the storage stability of these agents, and can influence their cleaning performance, in particular when the high concentration of the active substances leads to incompatibilities.

The formulation of concentrated high-performance liquid detergents is made more difficult by the growing requirements for the biodegradability of the active substances and packaging materials used, insofar as a person skilled in the art tasked with developing a detergent formula has a limited number of available substances that are active for washing and cleaning.

International application 2018/029021 A1 describes textile detergents containing cobuilders from the group of aminocarboxylates.

The object of the application was to provide visually appealing, concentrated flowable detergent preparations which can be produced in a simple and efficient manner, have a good storage life, and are characterized in particular by good cleaning results. In particular, the detergent preparation should be able to be prepared in water-soluble portion sachets and to a large extent based on ingredients which can be produced at least in part from renewable raw materials and are biodegradable.

A first subject of the application is a flowable detergent preparation containing, based on the total weight thereof,
a) 0.5 to 10 wt. % of a polyalkoxylated amine having a weight-average molecular weight M_{w} in the range from 600 g/mol to 10000 g/mol, which is obtainable by reacting ammonia or primary alkyl or hydroxyalkylamines having a molecular weight of less than 200 g/mol with alkylene oxides;
b) 0.1 to 5 wt. % of at least one builder selected from the group consisting of aminocarboxylic acids and salts thereof, preferably from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof and iminodiacetic acid (IDA) and salts thereof;
c) 12 to 40 wt. % of anionic surfactant;
d) 12 to 40 wt. % of non-ionic surfactant;
e) less than 20 wt. % of water.

The detergent preparation is flowable under standard conditions (20° C., 1013 mbar).

A first essential component of the detergent preparation is a specific polyalkoxylated amine at a proportion by weight of 0.5 to 10 wt. %. Preferred detergent preparations contain, based on their total weight, 2 to 8 wt. %, preferably 3 to 6 wt. %, polyalkoxylated amine. Corresponding weight portions have proven advantageous for the storage life, but in particular for the cleaning performance.

Preferred polyalkoxylated amines have a weight-average molecular weight M_{w} in the range from 1300 g/mol to 6000 g/mol, in particular from 1400 g/mol to 4500 g/mol. (The average molecular weights indicated here, and later optionally for other polymers, are weight-average molecular weights M_{w} which can in principle be determined by means of gel permeation chromatography with the aid of an RI detector, the measurement expediently being carried out against an external standard.) For their preparation, it is possible to start, in a known manner, from ammonia, a monoalkylamine, a monoalkylaminoamine or a monoalkyl-dialkanolamine or a mono-, di- or trialkanolamine, for example triethanolamine, methyl-, ethyl-, propyl- and isopropyl-diethanolamine, methyl-, ethyl-, propyl- and isopropyl-diisopropanolamine, tripropanolamine, triisopropanolamine, N,N-Di-(2-hydroxyethyl)cyclohexylamine, N,N-Di-(2-hydroxypropyl)cyclohexylamine, n-butylamine, n-hexylamine, n-octylamine, isopropylamine, sec-butylamine, tert-butylamine, cyclohexylamine, 2-ethylhexylamine, 2-phenylethylamine and mixtures thereof, which is reacted with an alkylene oxide, in particular selected from the group consisting of ethylene oxide, propylene oxide, butylene oxide and mixtures thereof, in particular with a mixture containing propylene oxide and preferably ethylene oxide, particularly preferably with propylene oxide. The polyalkoxylated amines thus obtainable may be block or random structures. Particular preference is given, inter alia, to a polyalkoxylated amine obtainable by propoxylation of triethanolamine, preferably having a length of the three side arms of 15 propylene oxide units in each case. Also preferred is a polyalkoxylated amine obtainable by propoxylation of triisopropanolamine, preferably having a length of the three side arms of 15 propylene oxide units in each case. Polyalkoxylated monoalkylamines having a linear, branched or cyclic alkyl group are likewise suitable, an alkylene oxide selected from the group consisting of ethylene oxide, propylene oxide, butylene oxide and mixtures thereof being alkoxylated, preferably with a mixture comprising propylene oxide, more preferably with propylene oxide. Preference is also given to a polyalkoxylated amine obtainable by propoxylation of tert-butylamine, preferably having a length of the two side arms of 12 propylene oxide units in each case.

Preferred polyalkoxylated amines satisfy the general formula (I),

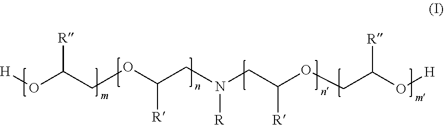

in which R represents a linear, optionally branched or optionally cyclic alkyl group having 1 to 12 C atoms or a —(CH₂CHR′O)_{n″}—(CH₂CHR″O)_{m″}—H group,
R′ and R″, independently of one another, represent H, CH₃ or CH₂CH₃,
n, n′ and n″, independently of one another, represent numbers from 0 to 30, preferably from 0 to 10 and in particular 0 to 5, and
m, m′ and m″, independently of one another, represent numbers from 0 to 30, preferably from 5 to 20 and in particular from 12 to 16,
with the proviso that the sum n+n′+n″+m+m′+m″ is at least 14, preferably in the range of from 18 to 100 and in particular in the range of from 20 to 70. Preferably, in the compounds of the formula I, at least one of the functional groups R′ and R″ is a CH₃ group.

A second essential component of the detergent preparation is a builder selected from the aminocarboxylic acids and salts thereof in proportions by weight of from 0.1 to 5 wt. %. Preferred detergent preparations contain, based on the total weight thereof, 0.2 to 4 wt. %, preferably 0.5 to 2 wt. %, of at least one builder selected from the group consisting of aminocarboxylic acids and salts thereof, preferably from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof and iminodiacetic acid (IDA) and salts thereof.

In particular, the use of ethylenediaminediacetic acid and iminodisuccinic acid has proven to be advantageous in the concentrated, low-water detergent preparations. It is therefore preferred if the detergent preparation contains, based on the total weight thereof, 0.1 to 5 wt. %, preferably 0.2 to 4 wt. %, particularly preferably 0.5 to 2 wt. % of at least one builder selected from the group of ethylenediaminediacetic acid (EDDS) and salts thereof and iminodisuccinic acid (IDS) and salts thereof.

To improve the cleaning performance, the ethylenediaminediacetic acid and iminodisuccinic acid are preferably combined with one another in the detergent preparations. Preferred detergent preparation therefore contain both ethylenediaminediacetic acid (EDDS) and iminodisuccinic acid (IDS), wherein the weight ratio of ethylenediaminediacetic acid (EDDS) to iminodisuccinic acid (IDS) is 5:1 to 1:5, preferably 3:1 to 1:3 and in particular 2:1 to 1:2.

As stated at the outset, improved biodegradability of the detergent preparations is desirable, which is why preferred detergent preparations, based on the total weight thereof, contain less than 1 wt. %, preferably less than 0.1 wt. % and in particular no phosphonate.

Preferred detergent preparations preferably also do not contain ethoxylated and quaternized hexamethylenediamine and/or ethoxylated polyethylenimine.

The third essential component of the detergent preparations is anionic surfactant.

The anionic surfactant is preferably selected from the group comprising C₉-C₁₃ alkylbenzene sulfonates, olefin sulfonates, C₁₂-C₁₈ alkane sulfonates, ester sulfonates, alk(en)yl sulfates, fatty alcohol ether sulfates and mixtures thereof. Compositions which comprise C₉-C₁₃ alkylbenzene sulfonates and fatty alcohol ether sulfates as the anionic surfactant have particularly good dispersing properties. In this case, preferably C₉-C₁₃ alkylbenzene sulfonates, olefin sulfonates, i.e. mixtures of alkene and hydroxyalkane sulfonates, and disulfonates, as obtained, for example, from C₁₂-C₁₈ monoolefins having a terminal or internal double bond by way of sulfonation with gaseous sulfur trioxide and subsequent alkaline or acid hydrolysis of the sulfonation products, are possible as surfactants of the sulfonate type. C₁₂-C₁₈ alkane sulfonates and the esters of α-sulfo fatty acids (ester sulfonates) are also suitable, for example the α-sulfonated methyl esters of hydrogenated coconut, palm kernel or tallow fatty acids.

It is very particularly preferred for the composition to contain at least one anionic surfactant of formula (I),

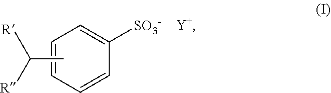

where
R′ and R″ are, independently of one another, H or alkyl, and together contain 9 to 19, preferably 9 to 15 and in particular 9 to 13, C atoms, and Y⁺ denotes a monovalent cation or the nth part of an n-valent cation (in particular monoethanolamine).

Preferred detergent preparations contain, based on their total weight, 15 to 30 wt. %, preferably 15 to 25 wt. %, anionic surfactant.

Although the detergent preparations may also contain other anionic surfactants in addition to the aforementioned C₈₋₁₈ alkylbenzenesulfonates, it has proven to be advantageous for the cleaning performance to limit their weight proportion.

The group of the alkyl ether sulfates include the fatty alcohol ether sulfates, such as the sulfuric acid monoesters of straight-chain or branched C₇-C₂₁ alcohols ethoxylated with 1 to 6 mol ethylene oxide, such as 2-methyl-branched C₉₋₁₁ alcohols having, on average, 3.5 mol ethylene oxide (EO) or C₁₂₋₁₈ fatty alcohols having 1 to 4 EO. Alkyl ether sulfates of formula (II) are preferred

R¹—O-(AO)ₙ—SO₃⁻X⁺ (II)

In this formula (II), R¹ is a linear or branched, substituted or unsubstituted alkyl functional group, preferably a linear, unsubstituted alkyl functional group, particularly preferably a fatty alcohol functional group. Preferred R¹ functional groups of formula (II) are selected from decyl, undecyl, dodecyl, tridecyl, tetradecyl, pentadecyl, hexadecyl, heptadecyl, octadecyl, nonadecyl, eicosyl functional groups and the mixtures thereof, the representatives having an even number of C atoms being preferred. Particularly preferred functional groups R¹ of formula (II) are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.

AO in formula (II) represents an ethylene oxide (EO) or propylene oxide (PO) group, preferably an ethylene oxide group. The index n in formula (I) is an integer from 1 to 50, preferably from 1 to 20, and in particular from 2 to 10. Very particularly preferably, n is 2, 3, 4, 5, 6, 7 or 8. X is a monovalent cation or the nth part of an n-valent cation, the alkali metal ions, including Na⁺ or K⁺, being preferred in this case, with Na⁺ being most preferred. Further cations X+ may be selected from NH₄⁺, ½ Zn²⁺, ½ Mg²⁺, ½ Ca2+, ½ Mn²⁺ and the mixtures thereof, as well as primary and secondary amines, in particular monoethanolamine.

Particularly preferred compositions contain an alkyl ether sulfate selected from fatty alcohol ether sulfates of formula (III)

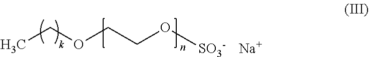

where k=11 to 19, and n=2, 3, 4, 5, 6, 7 or 8. Very particularly preferred representatives are Na fatty alcohol ether sulfates having 12 to 18 C atoms and 2 EO (k=11 to 13, n=2 in formula III). The degree of ethoxylation indicated represents a statistical average that can correspond to an integer or a fractional number for a specific product. The degrees of alkoxylation indicated represent statistical averages which can be an integer or a fractional number for a specific product. Preferred alkoxylates/ethoxylates have a narrowed homolog distribution (narrow range ethoxylates, NRE).

In summary, preferred detergent preparations contain, based on their total weight, 12 to 40 wt. %, preferably 15 to 30 wt. %, and in particular 18 to 25 wt. %, anionic surfactant from the group of the C₈₋₁₈ alkylbenzenesulfonates and alkyl ether sulfates, preferably from the group of the C₈₋₁₈ alkylbenzenesulfonates.

The use of fatty acids has proven advantageous for stability and cleaning performance. Preferred detergent preparations therefore contain, based on their total weight, 4 to 12 wt. %, preferably 6 to 10 wt. %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are not assigned to the group of anionic surfactants.

The detergent preparations contain non-ionic surfactant as a further essential component. Their proportion by weight of the total weight of the detergent preparation is preferably 15 to 30 wt. %, preferably 18 to 25 wt. %.

In particular the use of non-ionic surfactants from the group of alkyl ethoxylates is preferred, preferably alkyl ethoxylates from the group of the ethoxylated primary C₈₋₁₈ alcohols, preferably the ethoxylated primary C₈₋₁₈ alcohols having a degree of alkoxylation 4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO, being selected.

In summary, preferred detergent preparations contain, based on the total weight thereof, 12 to 40 wt. %, preferably 15 to 30 wt. % and in particular 18 to 25 wt. %, non-ionic surfactant from the group of the ethoxylated primary C₈₋₁₈ alcohols, preferably the ethoxylated primary C₈₋₁₈ alcohols having a degree of alkoxylation ≥4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

With regard to the rheological properties of the detergent preparation, the processability and cleaning effect thereof, it has proven advantageous to use non-ionic surfactant and anionic surfactant in a weight ratio of from 2:1 to 1:2, preferably from 3:2 to 2:3.

Preferred detergent preparations contain, based on their total weight, 5 to 18 wt. %, preferably 7 to 15 wt. %, water.

In addition to water, at least one organic solvent is preferably used as a further solvent. The use of aqueous-organic solvent systems has proven to be particularly advantageous for the producibility and storage life, and is therefore preferred.

In a preferred embodiment, the detergent preparation contains, based on its total weight, 5 to 30 wt. %, preferably 10 to 20 wt. %, organic solvent.

Preferred organic solvents are selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octyl ether and mixtures thereof, preferably from the group of propanediol, glycerol, ethanol, and mixtures thereof.

Due to their improved cleaning effect, detergent preparations are preferred which, as a further optional component, contain 2 to 8 wt. %, preferably 3 to 6 wt. %, enzyme preparation.

In addition to the actual enzyme protein, an enzyme preparation comprises further components such as enzyme stabilizers, carrier materials or fillers. In this case, the enzyme protein typically forms only a fraction of the total weight of the enzyme preparation. Enzyme preparations which are preferably used contain between 0.1 and 40 wt. %, preferably between 0.2 and 30 wt. %, more preferably between 0.4 and 20 wt. %, and most preferably between 0.8 and 10 wt. % of the enzyme protein. In such compositions, an enzyme stabilizer can be contained in an amount of 0.05 to 35 wt. %, preferably 0.05 to 10 wt. %, based on the total weight in the enzyme composition.

The protein concentration can be determined using known methods, for example the BCA method (bicinchoninic acid; 2,2′-bichinolyl-4,4′-dicarboxylic acid) or the Biuret method. The active protein concentration is determined in this regard via titration of the active centers using a suitable irreversible inhibitor (for proteases, for example, phenylmethylsulfonylfluoride (PMSF)), and determination of the residual activity.

It is preferred if the detergent preparation contains at least one enzyme preparation, preferably at least 3 enzyme preparations of enzymes from the group of lipase, amylase, protease, cellulase, preparations of a pectinolytic enzyme and endoglucanase.

According to the invention, it is preferred if the detergent preparation contains at least one lipase preparation. Lipases preferred according to the invention are selected from at least one enzyme of the group formed from triacylglycerol lipase (E.C. 3.1.1.3), and lipoprotein lipase (E.C. 3.1.1.34), and lipoprotein lipase (E.C. 3.1.1.23).

Preferred lipase preparations according to the invention are the commercial products marketed by Amano Pharmaceuticals under the names Lipase M-AP10®, Lipase LE® and Lipase F® (also Lipase JV®). For example, Lipase F® is naturally present in Rhizopus oryzae. Lipase M-AP10®, for example, is naturally present in Mucor javanicus.

A highly preferred lipase is commercially available from Novozymes (Denmark) under the trade name Lipex® and can advantageously be used in the detergent preparations according to the invention. The lipase Lipex® 100 L is particularly preferred here.

Preferred detergent preparations are characterized in that they contain, based on the total weight thereof, 0.01 to 1 wt. %, in particular 0.05 to 0.3 wt. %, lipase preparation.

The detergent preparations preferably contain at least one amylase, in particular an α-amylase. α-amylases (E.C. 3.2.1.1) hydrolyze as α-1,4-glycosidic bonds of starch and starch-like polymers which are internal to enzymes. By way of example, α-amylases from Bacillus licheniformis, from B. amyloliquefaciens and from B. stearothermophilus, as well as the developments thereof that have been improved for use in detergents or cleaning agents, may be mentioned. The enzyme from B. licheniformis is available from the company Novozymes under the trade name Termamyl® and from the company Genencor under the trade name Purastar® ST. Development products of this α-amylase are available from Novozymes under the trade names Duramyl® and Termamyl® ultra, from Genencor under the name Purastar® OxAm, and from Daiwa Seiko Inc., Tokyo, Japan, as Keistase®. The α-amylase from B. amyloliquefaciens is marketed by Novozymes under the name BAN®, and derived variants of the α-amylase from B. stearothermophilus are marketed under the names BSG® and Novamyl®, also by Novozymes. Examples for α-amylases from other organisms are the developments of α-amylase from Aspergillus niger and A. oryzae that are available under the trade name Fungamyl® from Novozymes.

The proportion by weight of the amylase preparation, in particular the amylase preparation, with respect to the total weight of the detergent preparation is preferably 0.1 to 2 wt. %, in particular 0.2 to 1 wt. %.

It is preferred according to the invention if at least one protease is contained in the detergent preparation as the enzyme. A protease is an enzyme that cleaves peptide bonds by hydrolysis. Each of the enzymes from class E.C. 3.4 according to the invention falls thereunder (comprising each of the thirteen subclasses which fall thereunder). According to the invention, “protease activity” is present if the enzyme has proteolytic activity (EC 3.4). Different types of protease-activity are known: The three main types are: trypsin-like, where the amide substrate is cleaved following the amino acids Arg or Lys at P1; chymotrypsin-like, where cleavage takes place following one of the hydrophobic amino acids at P1; and elastase-like, where the amide substrate is cleaved following Ala at P1.

Surprisingly, it was found that a protease of the type of alkaline protease from Bacillus lentus DSM 5483 or a protease sufficiently similar to this (based on the sequence identity) which has a plurality of these changes in combination is particularly suitable for use in the liquid detergent preparation according to the invention and advantageously stabilizes in an improved manner therein. Advantages of using this protease thus arise in particular with regard to wash performance and/or stability.

Very particularly preferably, the detergent preparation according to the invention contains protease of the alkaline protease type from Bacillus lentus DSM 5483 or a protease which is sufficiently similar to this (based on the sequence identity) and has a plurality of these modifications in combination.

The proportion by weight of the protease preparation with respect to the total weight of the detergent preparation is preferably 0.5 to 5 wt. % in particular 1.0 to 4 wt. %.

Preferred detergent preparations contain as an optional component, based on their total weight, from 0.05 to 2 wt. %, preferably from 0.1 to 0.4 wt. %, of a preparation of a pectinolytic enzyme.

In the context of the present invention, the pectinolytic enzymes include enzymes having the names pectinase, pectate lyase, pectin esterase, pectin demethoxylase, pectin methoxylase, pectin methylesterase, pectase, pectin methylesterase, pectinesterase, pectin pectyl hydrolase, pectin depolymerase, endopolygalacturonase, pectolase, pectin hydrolase, pectin polygalacturonase, 20 endopolygalacturonase, poly-α-1,4-galacturonide, glycanohydrolase, endogalacturonase, endo-D-galacturonase, galacturan 1,4-α-galacturonidase, exopolygalacturonase, poly(galacturonate) hydrolase, exo-D-galacturonase, exo-D-galacturonanase, exopoly-D-galacturonase, exopoly-α-galacturonosidase, exopolygalacturonosidase, or 25 exopolygalacturanosidase. The use of pectin lyases is very particularly preferred here.

Within the EC classification of enzymes, the numerical classification system for enzymes, the pectinolytic enzymes belong in particular to the enzyme classes (“Enzyme Commission number”) EC 3.1.1.11, EC 3.2.1.15, EC 3.2.1.67 and EC 3.2.1.82 and consequently belong to the third of the six main enzyme classes, the 10 hydrolases (E.C.3. hereunder to the glycosylases (E.C. 3.2.-.-) and again hereunder to the glycosidases (EC 3.2.1.-), i.e., enzymes which hydrolyze O- and/or S-glycosyl compounds. Consequently, pectinolytic enzymes act in particular against residues on dishes which contain pectic acid and/or other galacturonans, and catalyze the hydrolysis thereof.

In the context of the invention, pectate lyases are enzymes which catalyze the non-hydrolytic cleavage of pectate according to an endo mechanism.

Examples of suitable pectinolytic enzymes are the enzymes and enzyme preparations available under the trade names Gamanase®, Pektinex AR®, X-Pect® or Pectaway® from Novozymes, under the trade names Rohapect UF®, Rohapect TPL®, Rohapect PTE100®, Rohapect MPE®, 30 Rohapect MA plus HC, Rohapect DA12L®, Rohapect 10L®, Rohapect B1L® from AB Enzymes, and under the trade name Pyrolase® from Diversa Corp., San Diego, CA, USA.

As a preferred component, the detergent preparation contains 0.01 to 1 wt. %, preferably 0.02 to 0.3 wt. %, of a mannanase preparation.

A mannanase catalyzes the hydrolysis of 1,4-beta-D-mannosidic bonds in mannans, galactomannans, glucomannans and galactoglucomannans. Said mannanases are classified according to the enzyme nomenclature as E.C. 3.2.1.78.

The xantanases and mannanases characterizing the subject matter of the claims are preferably components of a more comprehensive enzyme system. In a preferred embodiment, due to their improved cleaning performance the detergent preparation therefore additionally contains, based on the total weight thereof, 2 to 8 wt. %, preferably 3 to 6 wt. %, enzyme preparation, in addition to the xanthanase and mannanase preparation.

As a further preferred optional component, the detergent preparations contain a cellulase preparation. Synonymous terms can be used for cellulases, in particular endoglucanase, endo-1,4-beta-glucanase, carboxymethyl cellulase, endo-1,4-beta-D-glucanase, beta-1,4-glucanase, beta-1,4-endoglucanhydrolase, celludextrinase or avicelase. Within the meaning of the invention, whether or not an enzyme is a cellulase is decided by its ability to hydrolyze 1,4-β-D-glucosidic bonds in cellulose.

Cellulases (endoglucanases, EG) suitable according to the invention include, for example, fungal compositions rich in endoglucanase (EG), which are provided by the company Novozymes under the trade name Celluzyme®. The products Endolase® and Carezyme®, also available from Novozymes, are based on 50 kD-EG and 43 kD-EG, respectively, from Humicola insolens DSM 1800. Further commercial products from this company that can be used are Cellusoft®, Renozyme®, and Celluclean®. It is also possible to use cellulases, for example, which are available from AB Enzymes, Finland, under the trade names Ecostone® and Biotouch®, and which are, at least in part, based on 20 kD-EG from Melanocarpus. Further cellulases from AB Enzymes are Econase® and Ecopulp®. Further suitable cellulases are from Bacillus sp. CBS 670.93 and CBS 669.93, wherein the cellulase from Bacillus sp. CBS 670.93 is available from Danisco/Genencor under the trade name Puradax®. Other commercial products from Danisco/Genencor that can be used are “Genencor detergent cellulase L” and IndiAge® Neutra.

The proportion by weight of the cellulase preparation with respect to the total weight of the detergent preparation is preferably 0.01 to 1 wt. %, in particular 0.05 to 0.3 wt. %.

As a further optional component, a preferred detergent preparation comprises 0.2 to 4 wt. %, preferably 0.5 to 3 wt. %, fragrance preparation.

In addition to the actual fragrances, the fragrance preparation comprises solvents, solid carrier materials or stabilizers, for example.

A fragrance is a chemical substance that stimulates the sense of smell. In order to be able to stimulate the sense of smell, the chemical substance should be able to be distributed in the air, at least in part, i.e., the fragrance should be volatile at 25° C., at least to a small degree. If the fragrance is very volatile, the odor intensity then decreases rapidly again. In the case of a lower volatility, however, the odor impression is more sustainable, i.e., it does not disappear as quickly. In one embodiment, the fragrance therefore has a melting point which is in the range from −100° C. to 100° C., preferably from −80° C. to 80° C., more preferably from −20° C. to 50° C., in particular from −30° C. to 20° C. In a further embodiment, the fragrance has a boiling point in the range from 25° C. to 400° C., preferably from 50° C. to 380° C., more preferably from 75° C. to 350° C., in particular from 100° C. to 330° C.

Overall, a chemical substance should not exceed a particular molecular mass in order to act as a fragrance, since the required volatility can no longer be ensured at too high a molecular mass. In one embodiment, the fragrance has a molecular mass of 40 to 700 g/mol, more preferably of 60 to 400 g/mol.

The odor of a fragrance is perceived as pleasant by most people, and frequently corresponds to the odor of, for example, flowers, fruits, spices, bark, resin, leaves, grasses, mosses and roots. Thus, fragrances can also be used to mask unpleasant odors or else to provide a non-smelling substance with a desired odor. Individual fragrance compounds, for example the synthetic products of the ester, ether, aldehyde, ketone, alcohol and hydrocarbon types, can be used as fragrances.

Preferably, mixtures of different fragrances are used, which together produce an attractive fragrance note. Such a mixture of fragrances can also be referred to as perfume or perfume oil. Perfume oils of this kind can also contain natural fragrance mixtures, as are obtainable from plant sources.

For the lengthening of the fragrance effect, it has proven advantageous to encapsulate the fragrance. In a corresponding embodiment, at least a portion of the fragrance is used in encapsulated form (fragrance capsules), in particular in microcapsules. However, the entire fragrance can also be used in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds which release the actual fragrance only after chemical conversion/cleavage, typically by the action of light or other ambient conditions, such as pH, temperature, etc. Such compounds are often also referred to as “pro-fragrances”.

The composition of some preferred flowable detergent preparations can be found in the following tables (information in wt. % based on the total weight of the preparation, unless otherwise indicated). The detergent preparations are particularly preferably packaged as detergent portion units in which the detergent preparation is completely enclosed by a water-soluble film.

| | Formula 1 | Formula 2 | Formula 3 | Formula 4 |
|---|---|---|---|---|
| Polyalkoxylated amine ¹⁾ | 0.5 to 10 | 2 to 8 | 2 to 8 | 3 to 6 |
| Aminocarboxylic acid ²⁾ | 0.1 to 5 | 0.1 to 5 | 0.2 to 4 | 0.5 to 2 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Water | <20 | 5 to 18 | 5 to 18 | 7 to 15 |
| Misc. | up to 100 | up to 100 | up to 100 | up to 100 |
| | Formula 6 | Formula 7 | Formula 8 | Formula 9 |
| Polyalkoxylated amine ¹⁾ | 0.5 to 10 | 2 to 8 | 2 to 8 | 3 to 6 |
| Aminocarboxylic acid ²⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Non-ionic surfactant | 12 to 40 | 15 to 30 | 15 to 30 | 18 to 25 |
| Water | <20 | 5 to 18 | 5 to 18 | 7 to 15 |
| Misc. | up to 100 | up to 100 | up to 100 | up to 100 |

| | Formula 11 | Formula 12 | Formula 13 | Formula 14 |
|---|---|---|---|---|
| Polyalkoxylated amine ¹⁾ | 0.5 to 10 | 2 to 8 | 2 to 8 | 3 to 6 |
| Aminocarboxylic acid ²⁾ | 0.1 to 5 | 0.1 to 5 | 0.2 to 4 | 0.5 to 2 |
| Anionic surfactant | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Water | <20 | 5 to 18 | 5 to 18 | 7 to 15 |
| Misc. | up to 100 | up to 100 | up to 100 | up to 100 |
| | Formula 16 | Formula 17 | Formula 18 | Formula 19 |
| Polyalkoxylated amine ¹⁾ | 0.5 to 10 | 2 to 8 | 2 to 8 | 3 to 6 |
| Aminocarboxylic acid ²⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Water | <20 | 5 to 18 | 5 to 18 | 7 to 15 |
| Misc. | up to 100 | up to 100 | up to 100 | up to 100 |

| | Formula 21 | Formula 22 | Formula 23 | Formula 24 |
|---|---|---|---|---|
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Water | <20 | 5 to 18 | 5 to 18 | 7 to 15 |
| Misc. | up to 100 | up to 100 | up to 100 | up to 100 |

| | Formula 26 | Formula 27 | Formula 28 | Formula 29 |
|---|---|---|---|---|
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Non-ionic surfactant | 12 to 40 | 15 to 30 | 15 to 30 | 18 to 25 |
| Water | <20 | 5 to 18 | 5 to 18 | 7 to 15 |
| Misc. | up to 100 | up to 100 | up to 100 | up to 100 |

| | Formula 31 | Formula 32 | Formula 33 | Formula 34 |
|---|---|---|---|---|
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Anionic surfactant | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Water | <20 | 5 to 18 | 5 to 18 | 7 to 15 |
| Misc. | up to 100 | up to 100 | up to 100 | up to 100 |
| | Formula 36 | Formula 37 | Formula 38 | Formula 39 |
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Water | <20 | 5 to 18 | 5 to 18 | 7 to 15 |
| Misc. | up to 100 | up to 100 | up to 100 | up to 100 |

| | Formula 41 | Formula 42 | Formula 43 | Formula 44 |
|---|---|---|---|---|
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Anionic surfactant | 12 to 40 | 15 to 30 | 15 to 30 | 18 to 25 |
| Non-ionic surfactant | 12 to 40 | 15 to 30 | 15 to 30 | 18 to 25 |
| Fatty acid ⁴⁾ | 4 to 12 | 4 to 12 | 6 to 10 | 6 to 10 |
| Enzyme preparation ⁵⁾ | 2 to 8 | 2 to 8 | 2 to 8 | 3 to 6 |
| Water | <20 | 5 to 18 | 5 to 18 | 7 to 15 |
| Misc. | up to 100 | up to 100 | up to 100 | up to 100 |

| | Formula 46 | Formula 47 | Formula 48 | Formula 49 |
|---|---|---|---|---|
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Non-ionic surfactant | 12 to 40 | 15 to 30 | 15 to 30 | 18 to 25 |
| Fatty acid ⁴⁾ | 4 to 12 | 4 to 12 | 6 to 10 | 6 to 10 |
| Enzyme preparation ⁵⁾ | 2 to 8 | 2 to 8 | 2 to 8 | 3 to 6 |
| Water | <20 | 5 to 18 | 5 to 18 | 7 to 15 |
| Misc. | up to 100 | up to 100 | up to 100 | up to 100 |

| | Formula 51 | Formula 52 | Formula 53 | Formula 54 |
|---|---|---|---|---|
| Polyalkoxylated amine ¹⁾ | | | | |
| Aminocarboxylic acid ³⁾ | | | | |
| Anionic surfactant | | | | |
| Ethoxylated primary C₈₋₁₈ alcohols | | | | |
| having a degree of alkoxylation ≥4 | | | | |
| Fatty acid ⁴⁾ | 4 to 12 | 4 to 12 | 6 to 10 | 6 to 10 |
| Enzyme preparation ⁵⁾ | 2 to 8 | 2 to 8 | 2 to 8 | 3 to 6 |
| Water | <20 | 5 to 18 | 5 to 18 | 7 to 15 |
| Misc. | up to 100 | up to 100 | up to 100 | up to 100 |
| | Formula 56 | Formula 57 | Formula 58 | Formula 59 |
| Polyalkoxylated amine ¹⁾ | 0.5 to 10 | 2 to 8 | 2 to 8 | 3 to 6 |
| Aminocarboxylic acid ³⁾ | 0.1 to 5 | 0.1 to 5 | 0.2 to 4 | 0.5 to 2 |
| Alkyl benzene sulfonic acid | 12 to 40 | 15 to 30 | 15 to 30 | 18 to 25 |
| Ethoxylated primary C₈₋₁₈ alcohols | 12 to 40 | 15 to 30 | 15 to 30 | 18 to 25 |
| having a degree of alkoxylation ≥4 | | | | |
| Fatty acid ⁴⁾ | 4 to 12 | 4 to 12 | 6 to 10 | 6 to 10 |
| Enzyme preparation ⁵⁾ | 2 to 8 | 2 to 8 | 2 to 8 | 3 to 6 |
| Water | <20 | 5 to 18 | 5 to 18 | 7 to 15 |
| Misc. | up to 100 | up to 100 | up to 100 | up to 100 |

¹⁾ polyalkoxylated amine having a weight-average molecular weight M_{w} in the range from 600 g/mol to 10000 g/mol, which is obtainable by reacting ammonia or primary alkyl or hydroxyalkylamines having a molecular weight of less than 200 g/mol, with alkylene oxides;
²⁾ builder selected from the group consisting of aminocarboxylic acids and salts thereof, preferably from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof and iminodiacetic acid (IDA) and salts thereof;
³⁾ combination of ethylenediaminediacetic acid (EDDS) and salts thereof and iminodisuccinic acid (IDS) and salts thereof in a weight ratio of 5:1 to 1:5;
⁴⁾ fatty acid from the group of caprylic acid, capric acid, lauric acid, myristic acid, palmitic acid, stearic acid, oleic acid, linoleic acid and mixtures thereof;
⁵⁾ at least 3 enzyme preparations of enzymes from the group of lipase, amylase, protease, cellulase, preparations of a pectinolytic enzyme and endoglucanase.

The previously described material systems are not only suitable for ensuring simple producibility, a good storage life and cleaning performance, but also enable the realization of a product appearance which is attractive to the consumer. For example, detergent preparations which are transparent and consequently have low turbidity are perceived as optically attractive. Preferred detergent preparations therefore have a turbidity (HACH Turbidimeter 2100Q, 20° C., 10 ml cuvette) below 100 NTU, preferably below 50 NTU, and in particular below 20 NTU. In the case of an NTU value (at 20° C.) of 60 or more, molded bodies exhibit a perceptible turbidity, within the meaning of the invention, identifiable by the naked eye.

The optical advantages of the concentrated detergent preparations come to bear in particular in packaging, which is in turn transparent and enables a direct view of the detergent composition. In addition to transparent plastic bottles, transparent bags, in particular water-soluble transparent bags, are therefore preferred for manufacturing and packaging.

A further preferred subject of this application is therefore a detergent portion unit comprising
i) a detergent preparation according to the invention
ii) a water-soluble film which completely surrounds the detergent preparation.

The water-soluble film in which the detergent preparation is packaged can comprise one or more structurally different water-soluble polymer(s). Suitable water-soluble polymer(s) are in particular polymers from the group of (optionally acetalized) polyvinyl alcohols (PVAL) and copolymers thereof.

Water-soluble films are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The production of the polyvinyl alcohol and polyvinyl alcohol copolymers generally includes the hydrolysis of intermediate polyvinyl acetate. Preferred polyvinyl alcohols and polyvinyl alcohol copolymers have a degree of hydrolysis of 70 to 100 mol. %, preferably 80 to 90 mol. %, particularly preferably 81 to 89 mol. %, and in particular 82 to 88 mol. %.

Preferred polyvinyl alcohol copolymers comprise, in addition to vinyl alcohol, an ethylenically unsaturated carboxylic acid, or the salt or ester thereof. In addition to vinyl alcohol, such polyvinyl alcohol copolymers particularly preferably contain sulfonic acids, such as 2-acrylamido-2-methyl-1-propanesulfonic acid (AMPS), acrylic acid, methacrylic acid, acrylic esters, methacrylic esters or mixtures thereof; among the esters, preference is given to C₁₋₄ alkyl esters or C₁₋₄ hydroxyalkyl esters. Ethylenically unsaturated dicarboxylic acids, for example itaconic acid, maleic acid, fumaric acid and mixtures thereof, are possible as further monomers.

Suitable water-soluble films for use are marketed, inter alia, by the company MonoSol LLC, for example under the name M8630, M8720, M8310, C8400 or M8900. For example, films with the name Solublon® PT, Solublon® GA, Solublon® KC or Solublon® KL by Aicello Chemical Europe GmbH or the VF-HP films by Kuraray are also suitable.

The water-soluble films can contain additional active ingredients or fillers, but also plasticizers and/or solvents, in particular water, as further ingredients.

In this case, the group of the further active ingredients includes, for example, materials which protect the ingredients of the preparation which are surrounded by the film material, from decomposition or deactivation by light irradiation. Antioxidants, UV absorbers and fluorescent dyes have proven to be particularly suitable here.

As plasticizers, it is possible to use, for example, glycerol, ethylene glycol, diethylene glycol, propanediol, 2-methyl-1,3-propanediol, sorbitol or mixtures thereof.

To reduce the coefficients of friction thereof, the surface of the water-soluble film of the detergent portion unit can optionally be powder-coated with fine powder. Sodium aluminosilicate, silicon dioxide, talc and amylose are examples of suitable powdering agents.

Preferred water-soluble films are suitable for processing in a deep-drawing apparatus.

The volume of the detergent portion unit is preferably from 12 to 25 ml, in particular from 12 to 18 ml.

Preferred detergent portion units have one to four receiving chambers, preferably three or four receiving chambers. In the case of detergent portion units having two or more receiving chambers, preferably at least one of the receiving chambers, preferably the majority of the receiving chambers, is transparent.

A further subject of the application is a method for cleaning textiles, in which a previously described detergent preparation or detergent portion unit is introduced into the washing liquor of a textile washing machine.

In preferred method variants, the detergent preparation or the detergent portion unit is metered directly into the drum or into the detergent drawer of the textile washing machine.

The machine textile washing process is preferably carried out at temperatures of 20° C. to 60° C., preferably of 30° C. to 45° C.

This application provides, inter alia, the following subjects:
1. A flowable detergent preparation containing, based on the total weight thereof,
a) 0.5 to 10 wt. % of a polyalkoxylated amine having a weight-average molecular weight M_{w} in the range from 600 g/mol to 10000 g/mol, which is obtainable by reacting ammonia or primary alkyl or hydroxyalkylamines having a molecular weight of less than 200 g/mol with alkylene oxides;
b) 0.1 to 5 wt. % of at least one builder selected from the group consisting of aminocarboxylic acids and salts thereof, preferably from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof and iminodiacetic acid (IDA) and salts thereof;
c) 12 to 40 wt. % of anionic surfactant;
d) 12 to 40 wt. % of non-ionic surfactant;
e) less than 20 wt. % of water.
2. The detergent preparation according to point 1, wherein the detergent preparation contains, based on the total weight thereof, 2 to 8 wt. %, preferably 3 to 6 wt. %, polyalkoxylated amine.
3. The detergent preparation according to one of the preceding points, wherein the polyalkoxylated amine has a weight-average molecular weight M_{w} in the range from 1300 g/mol to 6000 g/mol, in particular from 1400 g/mol to 4500 g/mol.
4. The detergent preparation according to one of the preceding points, wherein the detergent preparation contains, based on the total weight thereof, 0.2 to 4 wt. %, preferably 0.5 to 2 wt. %, of at least one builder selected from the group consisting of aminocarboxylic acids and salts thereof, preferably from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof and iminodiacetic acid (IDA) and salts thereof.
5. The detergent preparation according to one of the preceding points, wherein the detergent preparation contains, based on the total weight thereof, 0.1 to 5 wt. %, preferably 0.2 to 4 wt. %, particularly preferably 0.5 to 2 wt. %, of at least one builder selected from the group of ethylenediaminediacetic acid (EDDS) and salts thereof and iminodisuccinic acid (IDS) and salts thereof.
6. The detergent preparation according to point 5, wherein the detergent preparation contains ethylenediaminediacetic acid (EDDS) and iminodisuccinic acid (IDS) and the weight ratio of ethylenediaminediacetic acid (EDDS) to iminodisuccinic acid (IDS) is 5:1 to 1:5, preferably 3:1 to 1:3 and in particular 2:1 to 1:2.
7. The detergent preparation according to one of the preceding points, wherein the detergent preparation contains, based on the total weight thereof, less than 1 wt. %, preferably less than 0.1 wt. % and in particular no phosphonate.
8. The detergent preparation according to one of the preceding points, wherein the detergent preparation contains, based on the total weight thereof, 15 to 30 wt. %, preferably 18 to 25 wt. %, anionic surfactant.
9. The detergent preparation according to one of the preceding points, wherein the detergent preparation contains, based on the total weight thereof, 12 to 40 wt. %, preferably 15 to 30 wt. %, and in particular 18 to 25 wt. %, anionic surfactant from the group of the C₈₋₁₈ alkylbenzenesulfonates and alkyl ether sulfates, preferably from the group of the C₈₋₁₈ alkylbenzenesulfonates.
10. The detergent preparation according to one of the preceding points, wherein the detergent preparation contains, based on the total weight thereof, 15 to 30 wt. %, preferably 18 to 25 wt. %, non-ionic surfactant.
11. The detergent preparation according to one of the preceding points, wherein the detergent preparation contains, based on the total weight thereof, 12 to 40 wt. %, preferably 15 to 30 wt. % and in particular 18 to 25 wt. %, non-ionic surfactant from the group of the ethoxylated primary C₈₋₁₈ alcohols, preferably the ethoxylated primary C₈₋₁₈ alcohols having a degree of alkoxylation ≥4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.
12. The detergent preparation according to one of the preceding points, wherein the detergent preparation contains non-ionic surfactant and anionic surfactant in a weight ratio of from 3:1 to 1:3, preferably from 2:1 to 1:2 and in particular from 3:2 to 2:3.
13. The detergent preparation according to one of the preceding points, wherein the detergent preparation contains, based on the total weight thereof, 4 to 12 wt. %, preferably 6 to 10 wt. %, fatty acid.
14. The detergent preparation according to point 13, wherein the fatty acid is selected from the group of caprylic acid, capric acid, lauric acid, myristic acid, palmitic acid, stearic acid, oleic acid, linoleic acid and mixtures thereof.
15. The detergent preparation according to one of the preceding points, wherein the detergent preparation contains, based on the total weight thereof, 5 to 18 wt. %, preferably 7 to 15 wt. %, water.
16. The detergent preparation according to one of the preceding points, wherein the detergent preparation contains, based on the total weight thereof, 5 to 30 wt. %, preferably 10 to 20 wt. %, organic solvent.
17. The detergent preparation according to point 16, wherein the organic solvent is selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol tert-butyl ether, di-n-octyl ether and mixtures thereof, preferably from the group of propanediol, glycerol, ethanol and mixtures thereof.
18. The detergent preparation according to one of the preceding points, wherein the detergent preparation contains, based on the total weight thereof, 2 to 8 wt. %, preferably 3 to 6 wt. %, enzyme preparation.
19. The detergent preparation according to one of the preceding points, wherein the detergent preparation also contains at least one enzyme preparation, preferably at least 3 enzyme preparations of enzymes from the group of lipase, amylase, protease, cellulase, preparations of a pectinolytic enzyme, and endoglucanase.
20. The detergent preparation according to one of the preceding points, wherein the detergent preparation contains, based on the total weight thereof, 0.01 to 1 wt. %, preferably 0.05 to 0.3 wt. %, of a lipase preparation.
21. The detergent preparation according to one of the preceding points, wherein the detergent preparation contains, based on the total weight thereof, 0.1 to 2 wt. %, preferably 0.2 to 1 wt. %, of an amylase preparation.
22. The detergent preparation according to one of the preceding points, wherein the detergent preparation contains, based on the total weight thereof, 0.5 to 5 wt. %, preferably 1 to 4 wt. %, of a protease preparation.
23. The detergent preparation according to one of the preceding points, wherein the detergent preparation contains, based on the total weight thereof, 0.01 to 1 wt. %, preferably 0.02 to 0.3 wt. %, of a mannanase preparation.
24. The detergent preparation according to one of the preceding points, wherein the detergent preparation contains, based on the total weight thereof, 0.01 to 1 wt. %, preferably 0.05 to 0.3 wt. %, of a cellulase preparation.
25. The detergent preparation according to one of the preceding points, wherein the enzyme preparations, based on the total weight thereof, have a proportion by weight of active protein of 0.1 to 40 wt. %, preferably 0.2 to 30 wt. %.
26. The detergent preparation according to one of the preceding points, wherein the detergent preparation contains, based on the total weight thereof, 0.2 to 4 wt. %, preferably 0.5 to 3 wt. %, fragrance preparation.
27. The detergent preparation according to one of the preceding points, wherein the detergent preparation does not contain ethoxylated and quaternized hexamethylenediamine.
28. The detergent preparation according to one of the preceding points, wherein the detergent preparation does not contain ethoxylated and quaternized hexamethylenediamine.
29. The detergent preparation according to one of the preceding points, wherein the detergent preparation has a turbidity (HACH Turbidimeter 2100Q, 20° C., 10 ml cuvette) below 100 NTU, preferably below 50 NTU, and in particular below 20 NTU.
30. A detergent portion unit comprising
i) a detergent preparation according to one of points 1 to 29
ii) a water-soluble film which completely surrounds the detergent preparation.
31. The detergent portion unit according to point 30, wherein the detergent portion unit has a volume of 12 to 22 ml, preferably 12 to 18 ml.
32. The detergent portion unit according to one of the preceding points, wherein the detergent portion unit has one to four receiving chambers, preferably three or four receiving chambers.
33. A method for textile cleaning, in which a detergent preparation according to one of points 1 to 29 or a detergent portion unit according to one of points 30 to 32 is introduced into the washing liquor of a textile washing machine.

### EXAMPLES

Textile fabrics were provided with standardized contamination and subsequently washed at 40° C. in washing liquors after adding 17 g of a detergent V1 to V7 or E1 (Miele WCI 360, washing time 119 minutes with 17 L washing liquor). After washing, the textiles were dried. The brightness values of the cleaned textiles were determined. The stated values were obtained as mean values from five washing experiments.

TABLE 1
Detergent composition (wt. %)

| | V1 | V2 | V3 | V4 |
|---|---|---|---|---|
| 1,2-propanediol | 5.3 | 5.3 | 5.3 | 5.3 |
| Water | 11.5 | 11.5 | 11.5 | 11.5 |
| Monoethanolamine | 6.0 | 6.0 | 6.0 | 6.0 |
| Sodium disulphite | 0.07 | 0.07 | 0.07 | 0.07 |
| Glycerol | 9.8 | 9.8 | 9.8 | 9.8 |
| C12-18 fatty alcohol | 23 | 23 | 23 | 23 |
| ethoxylate, 7 EO | | | | |
| C10-13 alkylbenzene | 23 | 23 | 23 | 23 |
| sulfonic acid | | | | |
| C12-18 fatty acid | 7.0 | 7.0 | 7.0 | 7.0 |
| DTPMP (40% in water) | 2.5 | 2.5 | — | — |
| Bitrex (2.5% in water) | 0.05 | 0.05 | 0.05 | 0.05 |
| Optical brightener | 0.6 | 0.6 | 0.6 | 0.6 |
| Protease | 2.5 | 2.5 | 2.5 | 2.5 |
| Mannanase | 0.1 | 0.1 | 0.1 | 0.1 |
| Amylase | 0.4 | 0.4 | 0.4 | 0.4 |
| Cellulase | 0.15 | 0.15 | 0.15 | 0.15 |
| Alkoxylated | — | 4.5 | — | 4.5 |
| alkanolamine | | | | |
| EDDS | — | — | 1.0 | 1.0 |
| IDS | — | — | — | — |
| Misc. | up to 100 | up to 100 | up to 100 | up to 100 |

TABLE 2
Detergent composition (wt. %)

| | V5 | V6 | V7 | E1 |
|---|---|---|---|---|
| 1,2-propanediol | 5.3 | 5.3 | 5.3 | 5.3 |
| Water | 11.5 | 11.5 | 11.5 | 11.5 |
| Monoethanolamine | 6.0 | 6.0 | 6.0 | 6.0 |
| Sodium disulphite | 0.07 | 0.07 | 0.07 | 0.07 |
| Glycerol | 9.8 | 9.8 | 9.8 | 9.8 |
| C12-18 fatty alcohol | 23 | 23 | 23 | 23 |
| ethoxylate, 7 EO | | | | |
| C10-13 alkylbenzene | 23 | 23 | 23 | 23 |
| sulfonic acid | | | | |
| C12-18 fatty acid | 7.0 | 7.0 | 7.0 | 7.0 |
| DTPMP (40% in water) | — | — | — | — |
| Bitrex (2.5% in water) | 0.05 | 0.05 | 0.05 | 0.05 |
| Optical brightener | 0.6 | 0.6 | 0.6 | 0.6 |
| Protease | 2.5 | 2.5 | 2.5 | 2.5 |
| Mannanase | 0.1 | 0.1 | 0.1 | 0.1 |
| Amylase | 0.4 | 0.4 | 0.4 | 0.4 |
| Cellulase | 0.15 | 0.15 | 0.15 | 0.15 |
| Alkoxylated | — | 4.5 | — | 4.5 |
| alkanolamine | | | | |
| EDDS | — | — | 0.5 | 0.5 |
| IDS | 1.0 | 1.0 | 0.5 | 0.5 |
| Misc. | up to 100 | up to 100 | up to 100 | up to 100 |

TABLE 3
Brightness value differences (Y values)

| Spot | Textile | V1 | V2 | V3 | V4 | V5 | V6 | V7 | E1 |
|---|---|---|---|---|---|---|---|---|---|
| Mineral oil | Cotton | 45.3 | 45.9 | 45.8 | 46.1 | 45.2 | 46.4 | 45.3 | 46.6 |
| Red wine | Cotton | 42 | 42.7 | 42 | 42.5 | 42.5 | 42.6 | 43 | 43.2 |
| Sebum, carbon black | Cotton | 72.6 | 72.4 | 72.3 | 73.3 | 72.1 | 72.8 | 72.5 | 73.4 |
| Drinking chocolate | Cotton | 61 | 61.4 | 60 | 60.7 | 59.8 | 60 | 61.3 | 61.6 |
| Blood | Cotton | 55 | 55.8 | 55.5 | 54.7 | 54 | 54.7 | 55.8 | 56.4 |
| Spinach | Cotton | 67.5 | 67.9 | 67.6 | 67.4 | 67.1 | 67.7 | 67.6 | 68.3 |
| Egg yolk | Cotton | 85.4 | 85.1 | 84.9 | 85.1 | 85.2 | 85.2 | 85.3 | 85.5 |
| Butter, dye | Cotton | 75.8 | 76.3 | 75.3 | 75.2 | 74.7 | 75 | 76.1 | 76.4 |

1. A detergent preparation comprising:
a polyalkoxylated amine having an average molecular weight M_{w} of from 600 g/mol to 10000 g/mol, the polyalkoxylated amine being in an amount of from 0.5 to 10 wt. % based on the total weight of the detergent preparation;
at least one builder selected from the group consisting of aminocarboxylic acids and salts thereof, the at least one builder being in an amount of from 0.1 to 5 wt. % based on the total weight of the detergent preparation;
an anionic surfactant in an amount of from 12 to 40 wt. % based on the total weight of the detergent preparation;
a non-ionic surfactant in an amount of from 12 to 40 wt. % based on the total weight of the detergent preparation; and
water in an amount less than 20 wt. % based on the total weight of the detergent preparation.

2. The detergent preparation of claim 1, wherein the polyalkoxylated amine is in an amount of from 2 to 8 wt. % based on the total weight of the detergent preparation.

3. The detergent preparation of claim 1, wherein the at least one builder is in an amount of from 0.2 to 4 wt. % based on the total weight of the detergent preparation.

4. The detergent preparation of claim 1, wherein the aminocarboxylic acids and salts thereof are selected from the group consisting of ethylenediaminediacetic acid (EDDS) and salts thereof, and iminodisuccinic acid (IDS) and salts thereof.

5. The detergent preparation of claim 4, wherein the aminocarboxylic acids and salts thereof comprise the ethylenediaminediacetic acid (EDDS) and the iminodisuccinic acid (IDS), and wherein a weight ratio of the ethylenediaminediacetic acid (EDDS) to the iminodisuccinic acid (IDS) is of from 5:1 to 1:5.

6. The detergent preparation of claim 1, comprising phosphonate in an amount less than 1 wt. % based on the total weight of the detergent preparation.

7. The detergent preparation of claim 1, wherein a weight ratio of the non-ionic surfactant to the anionic surfactant is of from 3:1 to 1:3.

8. The detergent preparation of claim 1, wherein the water is in an amount of from 5 to 18 wt. % based on the total weight of the detergent preparation.

9. A detergent unit comprising:
the detergent preparation of claim 1; and
a water-soluble film completely surrounding the detergent preparation.

10. A method for cleaning textiles, the method comprising:
introducing the detergent preparation of claim 1 into a textile washing machine.

11. The detergent preparation of claim 1, wherein the detergent preparation is in the form of a liquid.

12. The detergent preparation of claim 1, wherein the polyalkoxylated amine is configured to be produced by reacting ammonia or primary alkyl or hydroxyalkylamines having a molecular weight of less than 200 g/mol with alkylene oxides.

13. The detergent preparation of claim 1, wherein the aminocarboxylic acids and salts thereof are selected from the group consisting of methylglycinediacetic acid (MGDA) and salts thereof, glutaminediacetic acid (GLDA) and salts thereof, ethylenediaminediacetic acid (EDDA) and salts thereof, iminodisuccinic acid (IDS) and salts thereof, and iminodiacetic acid (IDA) and salts thereof.

14. The detergent preparation of claim 2, wherein the polyalkoxylated amine is in an amount of from 3 to 6 wt. % based on the total weight of the detergent preparation.

15. The detergent preparation of claim 3, wherein the at least one builder is in an amount of from 0.5 to 2 wt. % based on the total weight of the detergent preparation.

16. The detergent preparation of claim 5, wherein the weight ratio of the ethylenediaminediacetic acid (EDDS) to the iminodisuccinic acid (IDS) is of from 2:1 to 1:2.

17. The detergent preparation of claim 6, wherein the phosphonate is in an amount less than 0.1 wt. % based on the total weight of the detergent preparation.

18. The detergent preparation of claim 1, wherein the detergent preparation does not comprise phosphonate.

19. The detergent preparation of claim 7, wherein a weight ratio of the non-ionic surfactant to the anionic surfactant is of from 3:2 to 2:3.

20. A method for cleaning textiles, the method comprising:
introducing the detergent unit of claim 9 into a textile washing machine.
